(19) United States
(12) Patent Application Publication
(10) Pub. No.: US 2017/0063612 A1
(43) Pub. Date: Mar. 2, 2017

(54) INFORMATION PROCESSING APPARATUS, INFORMATION PROCESSING SYSTEM, AND RECORDING MEDIUM

(71) Applicant: Hiroki MORI, Kanagawa (JP)

(72) Inventor: Hiroki MORI, Kanagawa (JP)

(73) Assignee: RICOH COMPANY, LTD., Tokyo (JP)

(21) Appl. No.: 15/246,969

(22) Filed: Aug. 25, 2016

(30) Foreign Application Priority Data
Aug. 26, 2015 (JP) 2015-167178

(51) Int. Cl. H04L 12/24; H04L 29/08

(52) U.S. Cl. CPC H04L 41/0803; H04L 67/34

(57) ABSTRACT

An information processing apparatus including: a storage unit configured to store device identification information that identifies devices, types of the devices, device-type common information to be written commonly to devices of each type, and device individual information to be written individually to the devices in association with each other; circuitry configured to receive device identification information of each device from the device; identify a type of the device, the type corresponding to the received device identification information, with reference to the storage unit; and generate setting information to be written to the device from device-type common information corresponding to the identified type of the device and device individual information corresponding to the identified type of the device and to the received device identification information.

### CROSS-REFERENCE TO RELATED APPLICATIONS

The present application claims priority under 35 U.S.C. §119 to Japanese Patent Application No. 2015-167178, filed Aug. 26, 2015. The contents of which are incorporated herein by reference in their entirety.

### BACKGROUND OF THE INVENTION

1. Field of the Invention

The present invention relates to an information processing apparatus, an information processing system, and a recording medium.

2. Description of the Related Art

When a device is an embedded product, product setting information needs to be written to the device after the hardware is assembled and before the device is shipped from factory. In an ordinary procedure for writing product setting information to a device, a dedicated personal computer (PC) transmits the product setting information to the device via a network, and the device writes the information. The product setting information varies depending on the type of devices, and thus, a plurality of dedicated PCs are needed to write the information to the devices. When various types of products (devices) are produced in a small batch, there is a problem in that preparation cost for the production and space for building writing environments increase.

To solve this problem, file writing systems that enable different types of devices to write product setting information have been developed (refer to Japanese Patent No. 4360888, for example). In such a file writing system, a dedicated PC that stores product setting information for different types of devices broadcasts the types of the product setting information that the dedicated PC stores. When a device receives a broadcast including information on the product setting information that the device needs to write, the device requests the dedicated PC to transmit a desired type of product setting information to the device. With this configuration, a single dedicate PC for writing product setting information can write product setting information to different types of devices.

However, there is a problem in that the conventional file writing system cannot write the product setting information to different types of devices under the same writing environment for the product setting information when the devices include a device of a certain type that needs to write product setting information including individual information specific to the device (for example, serial number, certificate, or time).

### SUMMARY OF THE INVENTION

According to one aspect of the present invention, an information processing apparatus is connected to a plurality of devices via a network. The information processing apparatus includes a storage unit and circuitry. The storage unit is configured to store device identification information that identifies the devices, types of the devices, device-type common information to be written commonly to devices of each type, and device individual information to be written individually to the devices in association with each other. The circuitry is configured to receive device identification information of each device from the device, identify a type of the device, the type corresponding to the received device identification information, with reference to the storage unit, acquire device-type common information corresponding to the identified type of the device with reference to the storage unit, acquire device individual information corresponding to the identified type of the device and to the received device identification information with reference to the storage unit, generate setting information to be written to the device from which the device identification information has been transmitted, from the acquired device-type common information and the acquired device individual information, and transmit the generated setting information to the device from which the device identification information has been transmitted.

### BRIEF DESCRIPTION OF THE DRAWINGS

FIG. 1 is a diagram illustrating the entire configuration of a writing system according to a first embodiment;

FIG. 2 is a diagram illustrating an example of product setting information to be written to devices;

FIG. 3 is a diagram illustrating a hardware configuration of a writing apparatus according to the first embodiment;

FIG. 4 is a diagram illustrating a hardware configuration of a printer according to the first embodiment;

FIG. 5 is a diagram illustrating a functional configuration of the writing apparatus according to the first embodiment;

FIG. 6 is a diagram illustrating an example of device identification information;

FIG. 7 is a diagram illustrating an example of device-type identifying information stored in a storage unit;

FIG. 8 is a diagram illustrating an example of common-information identifying information stored in the storage unit;

FIG. 9 is a diagram illustrating an example of individual item identifying information stored in the storage unit;

FIG. 10 is a diagram illustrating an example of individual-information identifying information stored in the storage unit;

FIG. 11 is a diagram illustrating a functional configuration of the printer (device) according to the first embodiment;

FIG. 12 is a sequence diagram illustrating the procedure for writing product setting information in the writing system according to the first embodiment;

FIG. 13 is a flowchart illustrating the procedure for generating the product setting information in the writing apparatus according to the first embodiment;

FIG. 14 is a diagram illustrating a functional configuration of a writing apparatus according to a second embodiment;

FIG. 15 is a diagram illustrating an example of common item identifying information stored in the storage unit;

FIG. 16 is a flowchart illustrating the procedure for generating product setting information in the writing apparatus according to the second embodiment;

FIG. 17 is a diagram illustrating the entire configuration of a writing system according to a third embodiment;

FIG. 18 is a diagram illustrating a functional configuration of a writing apparatus according to the third embodiment;

FIG. 19 is a diagram illustrating an example of management apparatus identifying information stored in the storage unit;

FIG. 20 is a flowchart illustrating the procedure for generating product setting information in the writing apparatus according to the third embodiment;

FIG. 21 is a diagram illustrating the entire configuration of a writing system according to a fourth embodiment;

FIG. 22 is a diagram illustrating a functional configuration of a writing apparatus according to the fourth embodiment;

FIG. 23 is a diagram illustrating an example of management apparatus identifying information stored in the storage unit;

FIG. 24 is a flowchart illustrating the procedure for generating product setting information in the writing apparatus according to the fourth embodiment;

FIG. 25 is a diagram illustrating the entire configuration of a writing system according to a fifth embodiment;

FIG. 26 is a diagram illustrating a functional configuration of a writing apparatus according to the fifth embodiment;

FIG. 27 is a diagram illustrating an example of communication mode identifying information stored in the storage unit; and

FIG. 28 is a flowchart illustrating the procedure for generating product setting information in the writing apparatus according to the fifth embodiment.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

The following describes embodiments of an information processing apparatus, an information processing system, and a recording medium in detail with reference to the accompanying drawings. The following embodiments describe the information processing apparatus according to the present invention as a writing apparatus configured by, for example, a PC, and the writing apparatus writes product setting information to different types of devices. The following embodiments describe a case in which the writing apparatus writes product setting information to a printer that is an example of the devices.

An embodiment has an object to provide an information processing device, an information processing system, and a recording medium that can write product setting information to different types of devices under the same writing environment for the product setting information even when the devices include a device of a certain type that needs to write product setting information including individual information specific to the device.

### First Embodiment

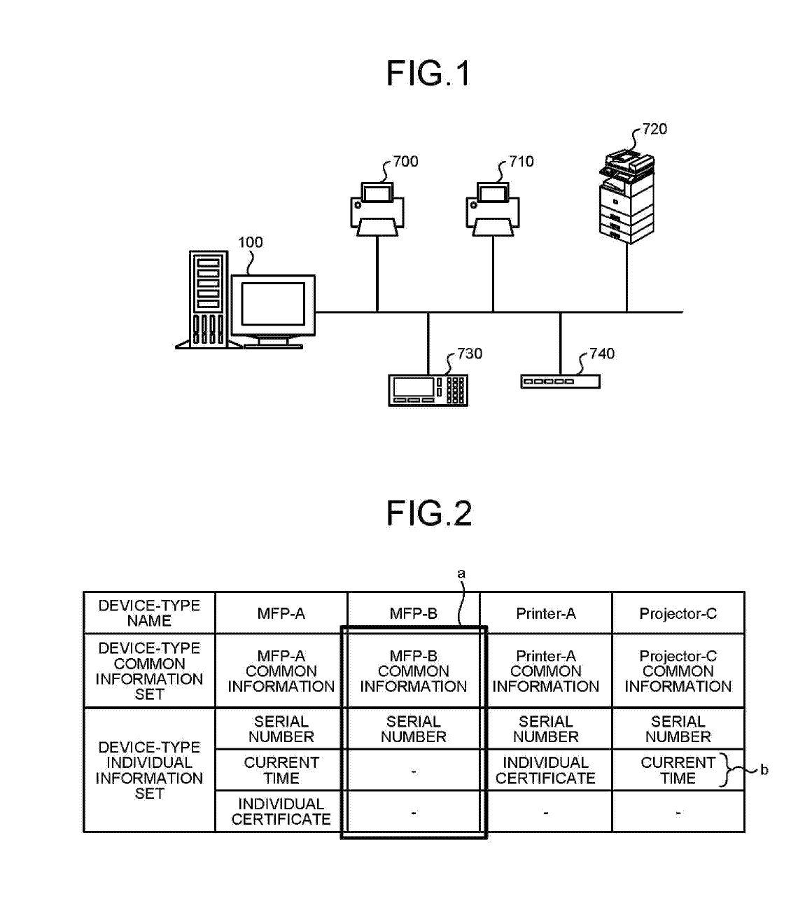

FIG. 1 is a diagram illustrating the entire configuration of a writing system according to a first embodiment. As illustrated in FIG. 1, in the writing system according to the first embodiment, a writing apparatus 100 is connected to a plurality of devices that are a printer 700, a printer 710, a multifunction peripheral (MFP) 720, a projector 730, and a network repeater 740 via a network.

Although the printers 700 and 710, the MFP 720, the projector 730, and the network repeater 740 are described as the examples of different types of devices, the examples may include any device that writes the product setting information, and the writing apparatus may be connected to any other devices. The following describes an example of writing product setting information from the writing apparatus 100 to the printer 700.

FIG. 2 is a diagram illustrating an example of the product setting information to be written to the devices. The product setting information varies depending on the types of the devices. In the first embodiment, the product setting information also includes setting information that varies from device to device.

Specifically, as illustrated in FIG. 2, the product setting information according to the first embodiment is configured by “device-type common information set” that is common information to be written to all the devices of the same type, and “device individual information set” that includes items in which the information items are common to all the devices of the same type but the content (actual value) thereof varies among the devices. In other words, device individual information in the first embodiment is information that varies from device to device.

For example, the reference sign a in FIG. 2 indicates product setting information for a device of a device type “MFP-B” in which the product setting information is generated by combining MFP-B common information that is device-type common information with a serial number that is device individual information.

In the first embodiment, as indicated by the reference sign b in FIG. 2, information items included in the “device individual information set” are referred to as “device individual information items” (for example, “current time”), and the actual value of each “device individual information item” is referred to as “device individual information” (for example, “9:47 pm”).

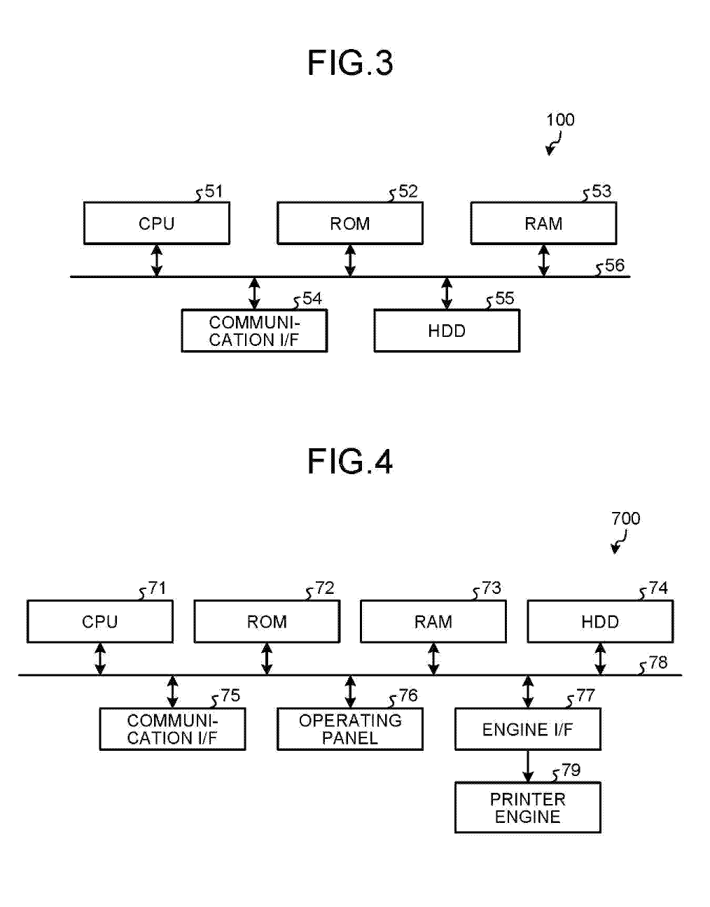

Described next is a hardware configuration of the writing apparatus 100 according to the first embodiment with reference to FIG. 3. FIG. 3 is a diagram illustrating the hardware configuration of the writing apparatus according to the first embodiment.

The writing apparatus 100 according to the first embodiment includes a controller such as a central processing unit (CPU) 51, memories such as a read only memory (ROM) 52 and a random access memory (RAM) 53, a communication I/F 54 that communicatively connects to a network, an external memory such as a hard disk drive (HDD) 55, a display device such as a display, an input device such as a keyboard and a mouse, and a bus 56 that connects these devices. The hardware configuration of the writing apparatus 100 is implemented by a general-purpose computer.

Described next is a hardware configuration of the printer 700 according to the first embodiment with reference to FIG. 4. FIG. 4 is a diagram illustrating the hardware configuration of the printer according to the first embodiment.

As illustrated in FIG. 4, the printer 700 includes a CPU 71, a ROM 72, a RAM 73, an HDD 74, a communication I/F 75, an operating panel 76, and an engine I/F 77, and these devices are communicatively connected to each other via a bus 78.

The CPU 71 is a processing unit for controlling the entire operation of the printer 700. The ROM 72 is a non-volatile memory that stores a computer program for the printer 700. The RAM 73 is a volatile memory used as a work area of the CPU 71 for processing. The HDD 74 is a storage device for storing various types of data such as image data and print data.

The communication I/F 75 is an interface for communicating data using the network. The operating panel 76 is, for example, a touch panel that receives inputs to the printer 700 and displays the state and conditions of the printer 700.

The engine I/F 77 is an interface for communicating with a printer engine 79. The printer engine 79 is a hardware device that implements the scanner function, the printer function, and other functions of the printer 700.

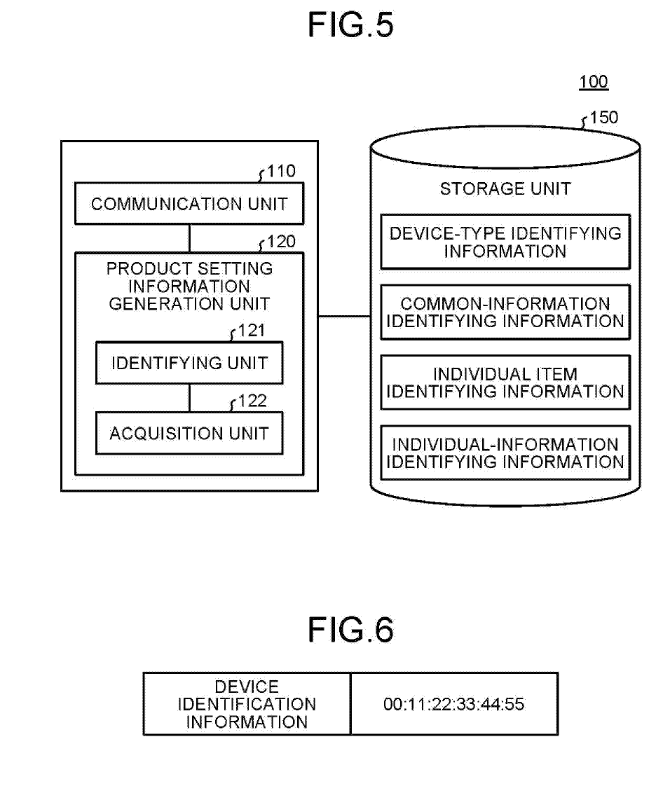

Described next is a functional configuration of the writing apparatus 100 according to the first embodiment with reference to FIG. 5. FIG. 5 is a diagram illustrating the functional configuration of the writing apparatus according to the first embodiment. As illustrated in FIG. 5, the writing apparatus 100 includes a communication unit 110 and a product setting information generation unit 120, and these units can access a storage unit 150 implemented by, for example, the HDD 55.

The communication unit 110 transmits and receives various types of information to and from the devices (such as the printer 700) connected to the network. The communication unit 110 corresponds to a reception unit and a transmission unit. The communication unit 110 transmits, to the devices connected via the network, a request for device identification information that identifies each device, and receives device identification information from the devices. In the first embodiment, the communication unit 110 transmits a request for device identification information to the printer 700 and receives, from the printer 700, device identification information of the printer 700. The communication unit 110 transmits product setting information generated by the product setting information generation unit 120 to the device from which the device identification information has been transmitted, that is, to the printer 700 in the first embodiment.

Device identification information is now described. FIG. 6 is a diagram illustrating an example of device identification information. Device identification information is information for uniquely identifying a device in a communication network. As illustrated in FIG. 6, the device identification information used in the first embodiment is a media access control (MAC) address. Specifically in FIG. 6, for example, the device identification information is “00:11:22:33:44:55”. The device identification information may be other information or methods that can uniquely identify a device from devices of different types in the writing process of the product setting information.

The storage unit 150 stores therein device-type identifying information, common-information identifying information, individual item identifying information, individual-information identifying information, and actual values of these types of information.

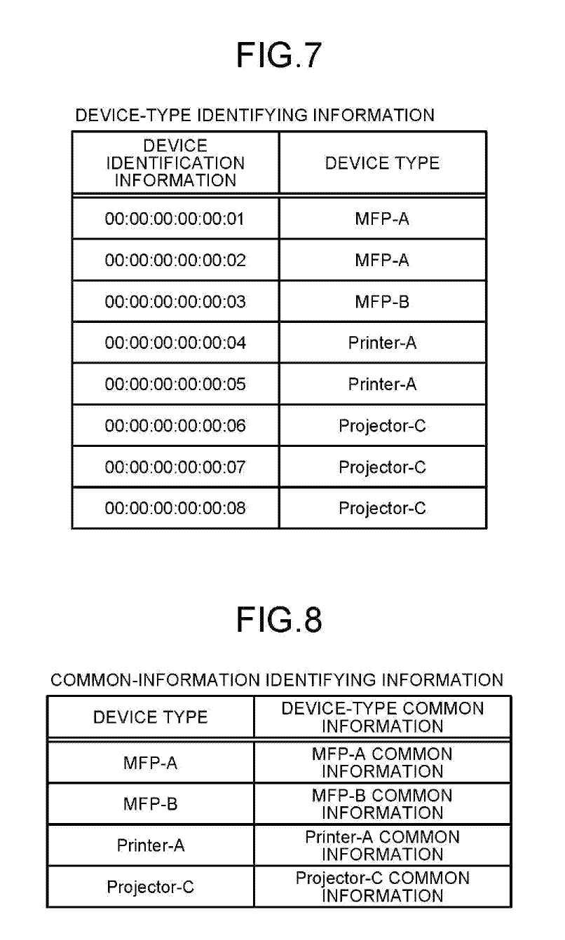

FIG. 7 is a diagram illustrating an example of device-type identifying information stored in the storage unit. As illustrated in FIG. 7, the device-type identifying information associates device identification information that identifies the devices with the types of the devices.

Specifically, for example, as illustrated in FIG. 7, the device-type identifying information associates device identification information “00:00:00:00:00:01” with a device type “MFP-A” of the device. For example, the device-type identifying information associates device identification information “00:00:00:00:00:04” with a device type “Printer-A” of the device. With reference to the device-type identifying information, a device type corresponding to device identification information can be identified.

FIG. 8 is a diagram illustrating an example of common-information identifying information stored in the storage unit. As illustrated in FIG. 8, the common-information identifying information associates the types of the devices with device-type common information that is product setting information to be written commonly to devices of each type.

Specifically, for example, as illustrated in FIG. 8, the common-information identifying information associates the device type “MFP-A” with device-type common information “MFP-A common information”. With reference to the common-information identifying information, device-type common information corresponding to each type of the devices can be obtained.

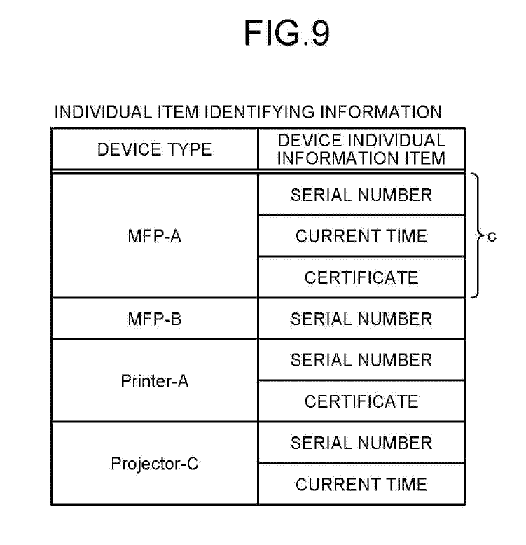

FIG. 9 is a diagram illustrating an example of individual item identifying information stored in the storage unit. As illustrated in FIG. 9, the individual item identifying information associates the types of the devices with device individual information items indicating items of device individual information that is setting information to be written individually to the devices.

Specifically, for example, as illustrated in FIG. 9, the individual item identifying information associates the device type “MFP-A” with device individual information items “serial number, current time, and certificate”. In other words, the reference sign c in FIG. 9 indicates the device individual information set for MFP-A. With reference to the individual item identifying information, device individual information items corresponding to each type of the devices can be identified.

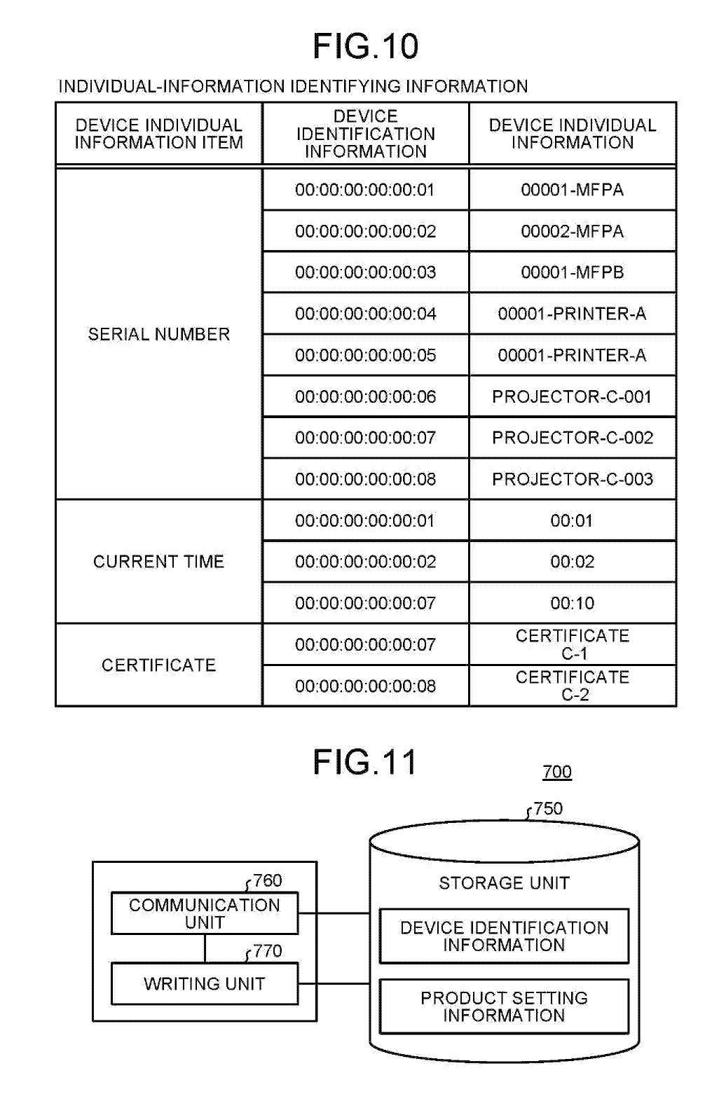

FIG. 10 is a diagram illustrating an example of individual-information identifying information stored in the storage unit. As illustrated in FIG. 10, the individual-information identifying information associates device individual information items, device identification information and device individual information that is setting information to be written individually to the devices.

Specifically, for example, the individual-information identifying information associates a device individual information item “serial number” with the device identification information “00:00:00:00:00:01” and device individual information “00001-MFPA”. For example, the individual-information identifying information associates a device individual information item “current time” with the device identification information “00:00:00:00:00:01” and device individual information “00:01”. With reference to the individual-information identifying information, device individual information corresponding to device identification information for each device individual information item can be obtained from the storage unit 150.

The product setting information generation unit 120 generates product setting information, and includes a identifying unit 121 and an acquisition unit 122.

The identifying unit 121 identifies the type of a device corresponding to the received device identification information with reference to the device-type identifying information (FIG. 7). The identifying unit 121 corresponds to a device-type identifying unit.

The acquisition unit 122 acquires, from the storage unit 150, device-type common information corresponding to the identified type of the device with reference to the common-information identifying information (FIG. 8). The acquisition unit 122 corresponds to a common information acquisition unit.

The identifying unit 121 identifies device individual information items corresponding to the identified type of the device with reference to the individual item identifying information (FIG. 9). The identifying unit 121 corresponds to an individual item identifying unit.

The acquisition unit 122 acquires, from the storage unit 150, device individual information corresponding to a combination of a identified device individual information item and the received device identification information with reference to the individual-information identifying information (FIG. 10). The acquisition unit 122 corresponds to an individual information acquisition unit.

The product setting information generation unit 120 combines the device-type common information with the device individual information, which are acquired by the acquisition unit 122, to generate the product setting information to be written to the device from which the device identification information has been transmitted. The product setting information generation unit 120 corresponds to a setting information generation unit.

Described next is a functional configuration of the printer 700 according to the first embodiment with reference to FIG. 11. FIG. 11 is a diagram illustrating the functional configuration of the printer (device) according to the first embodiment. As illustrated in FIG. 11, the printer 700 includes a communication unit 760 and a writing unit 770, and these units can access a storage unit 750 implemented by, for example, the HDD 74.

The storage unit 750 stores therein the device identification information that identifies the printer 700, and stores therein product setting information received by the communication unit 760.

The communication unit 760 transmits and receives various types of information to and from the writing apparatus 100 connected to the network. Upon receiving a request for device identification information from the writing apparatus 100 connected via the network, the communication unit 760 acquires the device identification information that identifies the printer 700 from the storage unit 750 and transmits the acquired device identification information to the writing apparatus 100. The communication unit 760 receives the generated product setting information and a writing request for writing the product setting information from the writing apparatus 100.

Upon receiving a notification of the received product setting information from the communication unit 760, the writing unit 770 writes the product setting information into the storage unit 750.

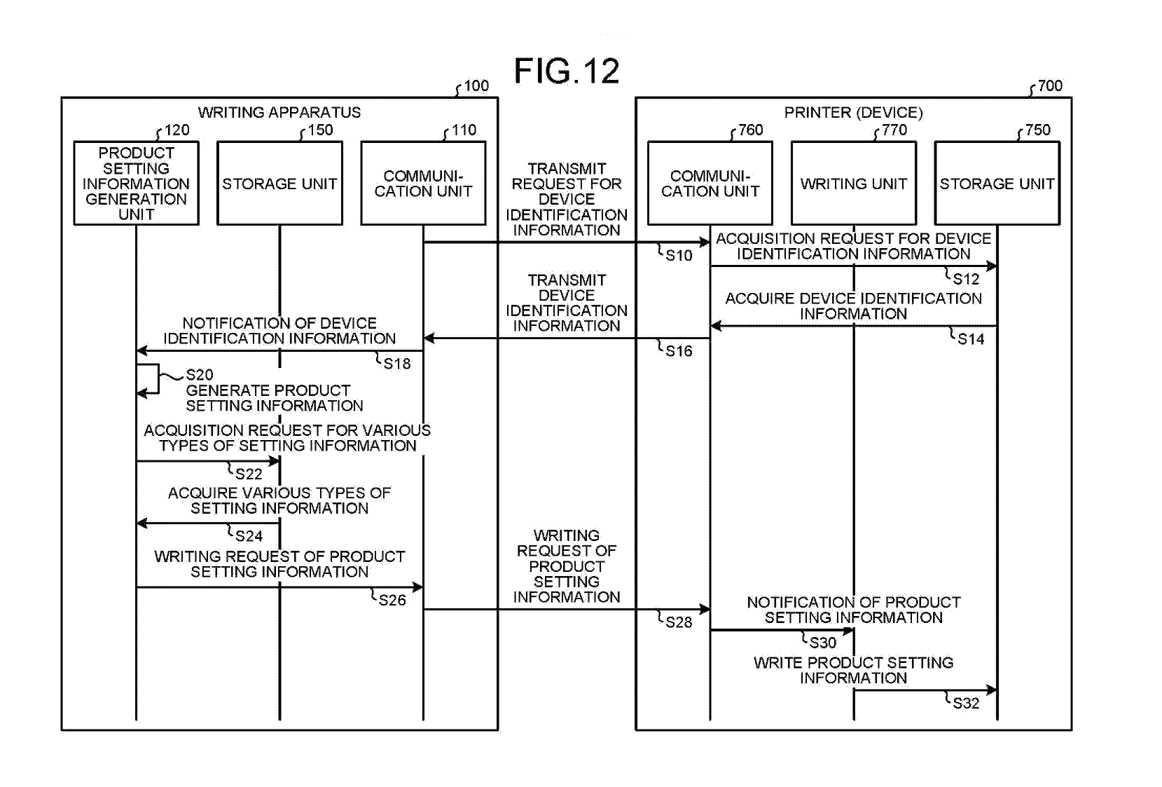

Described next is the procedure for writing the product setting information transmitted from the writing apparatus 100 to the devices such as the printer 700 in the writing system according to the first embodiment. FIG. 12 is a sequence diagram illustrating the procedure for writing the product setting information in the writing system according to the first embodiment.

First, the communication unit 110 of the writing apparatus 100 transmits a request for device identification information (Step S10). The writing apparatus 100 has no information on the Internet protocol (IP) addresses of the devices such as the printer 700, and thus, the writing apparatus 100 requests the device identification information by broadcast or a brute-force approach to the IP addresses.

Upon receiving the request for device identification information, the communication unit 760 of the printer 700 sends an acquisition request for the device identification information to the storage unit 750 (Step S12), and acquires the device identification information (Step S14). The communication unit 760 transmits the acquired device identification information to the writing apparatus 100 (Step S16).

Upon receiving the device identification information, the communication unit 110 of the writing apparatus 100 notifies the product setting information generation unit 120 of the device identification information (Step S18). The product setting information generation unit 120 generates product setting information to be written to the printer 700 based on the device identification information (Step S20), sends an acquisition request for various types of setting information to the storage unit 150 (Step S22), and acquires the various types of setting information (actual values) (Step S24). The product setting information is thus generated.

The product setting information generation unit 120 transmits the generated product setting information and a writing request for writing the generated product setting information to the printer 700 through the communication unit 110 (Step S26, Step S28). The communication unit 760 of the printer 700 receives the product setting information and the writing request for writing the product setting information, and then sends the product setting information to the writing unit 770 (Step S30). The writing unit 770 writes the received product setting information into the storage unit 750 (Step S32).

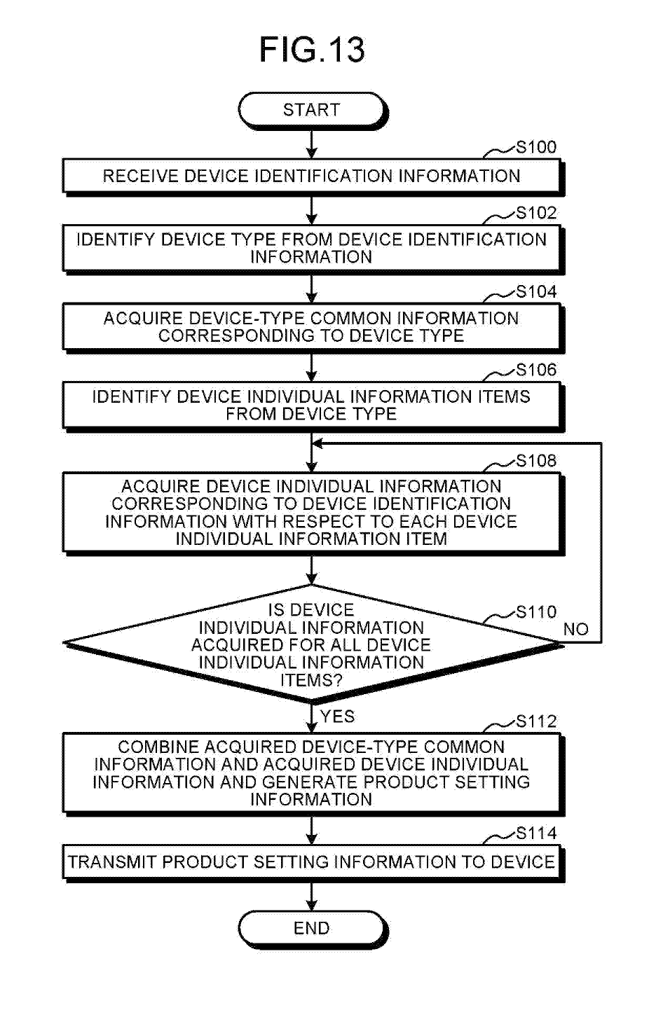

Described next is generation processing of the product setting information in the writing apparatus 100 according to the first embodiment. FIG. 13 is a flowchart illustrating the procedure for generating the product setting information in the writing apparatus according to the first embodiment.

The communication unit 110 transmits a request for device identification information to the devices, and receives device identification information from each device (Step S100). The identifying unit 121 identifies the type of a device corresponding to the received device identification information with reference to the device-type identifying information (Step S102). The acquisition unit 122 acquires device-type common information corresponding to the identified type of the device with reference to the common-information identifying information (Step S104).

The identifying unit 121 identifies device individual information items corresponding to the identified type of the device with reference to the individual item identifying information (Step S106). The acquisition unit 122 acquires device individual information corresponding to the received device identification information for each item of the identified device individual information items with reference to the individual-information identifying information (Step S108). In other words, the acquisition unit 122 acquires device individual information corresponding to each combination of a identified device individual information item and the received device identification information with reference to the individual-information identifying information.

The acquisition unit 122 determines whether the acquisition unit 122 has acquired the device individual information for all the identified device individual information items (Step S110). If the acquisition unit 122 has not acquired the device individual information (No at Step S110), the processing returns to Step S108.

If the acquisition unit 122 has acquired the device individual information (Yes at Step S110), the product setting information generation unit 120 combines the acquired device-type common information with the acquired device individual information to generate product setting information (Step S112). The communication unit 110 transmits the generated product setting information to the device from which the device identification information has been transmitted (Step S114). The product setting information is written to the device.

As described above, in the writing system according to the first embodiment, the writing apparatus identifies the type of a device from device identification information received from the device, acquires device-type common information corresponding to the identified type, and acquires device individual information corresponding to the device from device individual information items corresponding to the type of the device. The writing apparatus combines the acquired device-type common information with the acquired device individual information to generate product setting information, and transmits the product setting information to the device. The device writes the received product setting information. With this configuration, product setting information can be written to different types of devices under the same writing environment for the product setting information even when the devices include a device of a certain type that needs to write product setting information including individual information specific to the device.

### Second Embodiment

The writing apparatus according to the first embodiment acquires device-type common information corresponding to the type of a device identified from the device identification information, and generates the product setting information. In other words, the device-type common information is determined in accordance with the type of a device. In a second embodiment, the writing apparatus acquires items of the device-type common information corresponding to the type of a device, acquires device-type common information corresponding to each acquired item, and generates the product setting information.

The entire configuration of the writing system is the same as in the first embodiment and thus the explanation thereof is omitted. The hardware configuration of the writing apparatus and the printer that is an example of the devices is the same as in the first embodiment and thus the explanation thereof is omitted.

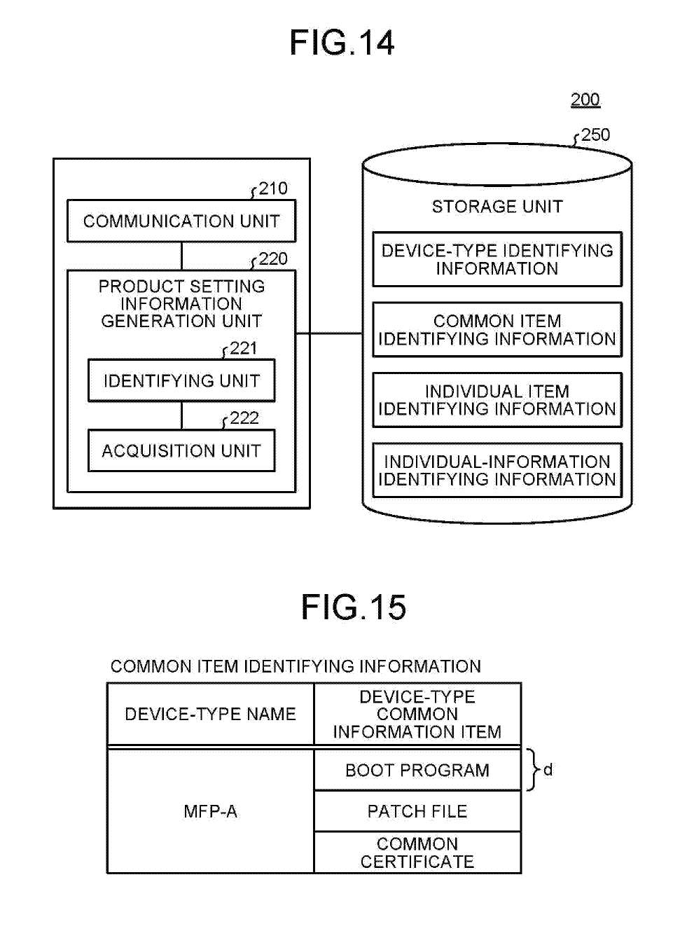

Described next is a functional configuration of a writing apparatus 200 according to the second embodiment with reference to FIG. 14. FIG. 14 is a diagram illustrating the functional configuration of the writing apparatus according to the second embodiment. As illustrated in FIG. 14, the writing apparatus 200 includes a communication unit 210 and a product setting information generation unit 220, and these units can access a storage unit 250 implemented by, for example, the HDD 55. The configuration and function of the communication unit 210 are the same as in the first embodiment.

The storage unit 250 stores therein device-type identifying information, common item identifying information, individual item identifying information, individual-information identifying information, and actual values of these types of information. The device-type identifying information, the individual item identifying information, and the individual-information identifying information are the same as in the first embodiment.

FIG. 15 is a diagram illustrating an example of common item identifying information stored in the storage unit. As illustrated in FIG. 15, the common item identifying information associates the types of the devices with device-type common information items that indicate items of the device-type common information.

Specifically, for example, as illustrated in FIG. 15, the common item identifying information associates the device type “MFP-A” with device-type common information items “boot program, patch file, and common certificate”. In other words, for example, the reference sign d in FIG. 15 indicates a device-type common information item of the device-type common information set for MFP-A. With reference to the common item identifying information, device-type common information items corresponding to each type of the devices can be identified.

The product setting information generation unit 220 generates product setting information, and includes a identifying unit 221 and an acquisition unit 222.

The identifying unit 221 identifies the type of a device from device identification information, and identifies device individual information items from the type of the device in the same manner as in the first embodiment.

The identifying unit 221 identifies device-type common information items corresponding to the identified type of the device with reference to the common item identifying information (FIG. 15). The identifying unit 221 corresponds to a common item identifying unit.

The acquisition unit 222 acquires device individual information corresponding to the identified device individual information items in the same manner as in the first embodiment.

The acquisition unit 222 acquires the actual value of device-type common information corresponding to each identified device-type common information item from the storage unit 250. With this configuration, the device-type common information can be dynamically created by acquiring device-type common information from device-type common information items.

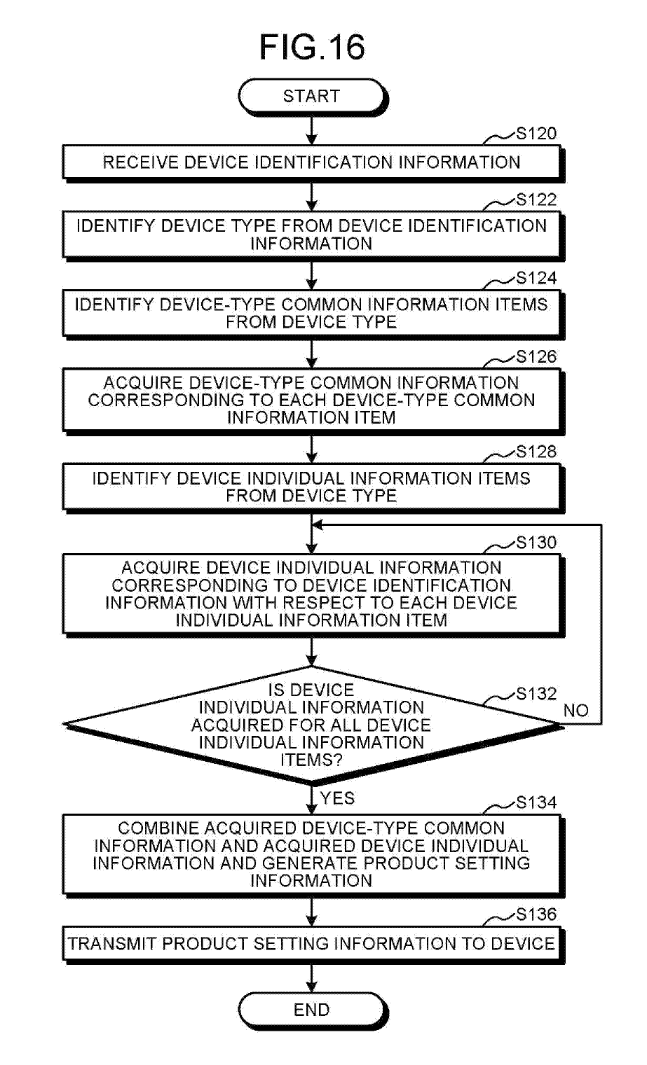

Described next is generation processing of the product setting information in the writing apparatus 200 according to the second embodiment. FIG. 16 is a flowchart illustrating the procedure for generating the product setting information in the writing apparatus according to the second embodiment.

The communication unit 210 transmits a request for device identification information to the devices, and receives device identification information from each device (Step S120). The identifying unit 221 identifies the type of a device corresponding to the received device identification information with reference to the device-type identifying information (Step S122).

The identifying unit 221 identifies device-type common information items corresponding to the identified type of the device with reference to the common item identifying information (Step S124). The acquisition unit 222 acquires device-type common information corresponding to the identified device-type common information items (Step S126).

The steps (from Step S128 to Step S136) from specification of device individual information items to the end of the processing are the same as the steps (see Step S106 to Step S114) in the first embodiment and thus the explanation thereof is omitted.

As described above, in the writing system according to the second embodiment, the writing apparatus identifies the type of a device from device identification information received from the device, acquires device-type common information corresponding to the identified type from device-type common information items corresponding to the identified type, and acquires device individual information corresponding to the device from device individual information items corresponding to the type of the device. The writing apparatus combines the acquired device-type common information with the acquired device individual information to generate product setting information, and transmits the product setting information to the device. The device writes the received product setting information. With this configuration, product setting information can be written to different types of devices under the same writing environment for the product setting information even when the devices include a device of a certain type that needs to write product setting information including individual information specific to the device.

The writing apparatus 200 according to the second embodiment can dynamically create the device-type common information by acquiring actual values of device-type common information from device-type common information items. This configuration allows efficient use of the storage area in the storage unit 250 when different types of devices use setting information common to the devices as the device-type common information.

### Third Embodiment

The writing apparatus according to the first embodiment stores the device-type common information in the storage unit of the writing apparatus. In a third embodiment, the device-type common information is managed by management apparatuses connected via the network, and the device-type common information is acquired from the management apparatuses.

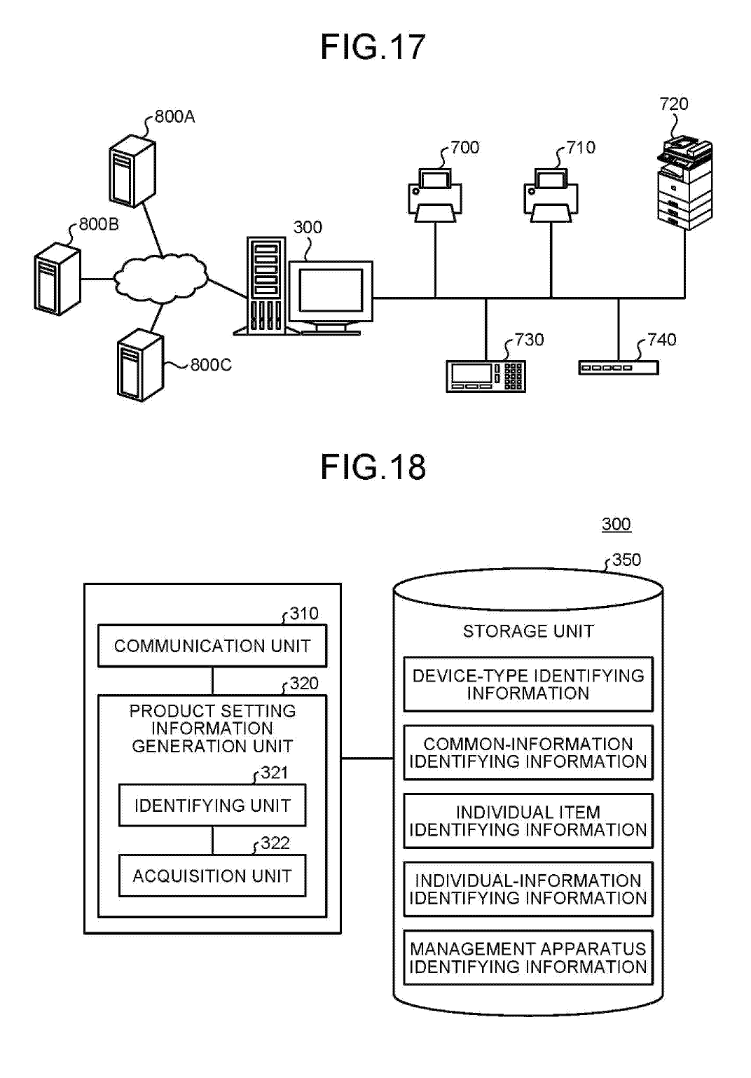

FIG. 17 is a diagram illustrating the entire configuration of a writing system according to the third embodiment. As illustrated in FIG. 17, in the writing system according to the third embodiment, a writing apparatus 300 is connected to a plurality of devices that are the printer 700, the printer 710, the MFP 720, the projector 730, and the network repeater 740 via a network. In the writing system according to the third embodiment, management apparatuses 800A, 800B, and 800C are connected to the writing apparatus 300 via the network.

As described in the first embodiment, the devices in FIG. 17 are presented for illustrative purposes only. Although three management apparatuses are connected in the example of FIG. 17, the number of management apparatuses connected to the writing apparatus is not limited to three.

The hardware configuration of the writing apparatus and the printer that is an example of the devices is the same as in the first embodiment and thus the explanation thereof is omitted.

Described next is a functional configuration of the writing apparatus 300 according to the third embodiment with reference to FIG. 18. FIG. 18 is a diagram illustrating the functional configuration of the writing apparatus according to the third embodiment. As illustrated in FIG. 18, the writing apparatus 300 includes a communication unit 310 and a product setting information generation unit 320, and these units can access a storage unit 350 implemented by, for example, the HDD 55.

The communication unit 310 transmits and receives various types of information to and from the devices (such as the printer 700) and the management apparatuses 800A, 800B, and 800C that are connected to the network. The communication unit 310 transmits, to the devices connected via the network, a request for device identification information that identifies each device, and receives device identification information from the devices. In the third embodiment, the communication unit 310 transmits a request for device identification information to the printer 700 and receives, from the printer 700, the device identification information of the printer 700.

Upon receiving an instruction from an acquisition unit 322, the communication unit 310 transmits a request for device-type common information to a desired management apparatus, and receives the device-type common information from the management apparatus. The communication unit 310 transmits product setting information generated by the product setting information generation unit 320 to the device from which the device identification information has been transmitted, that is, to the printer 700 in the third embodiment.

The storage unit 350 stores therein device-type identifying information, common-information identifying information, individual item identifying information, individual-information identifying information, management apparatus identifying information, and actual values of these types of information. The device-type identifying information, the common-information identifying information, the individual item identifying information, and the individual-information identifying information are the same as in the first embodiment.

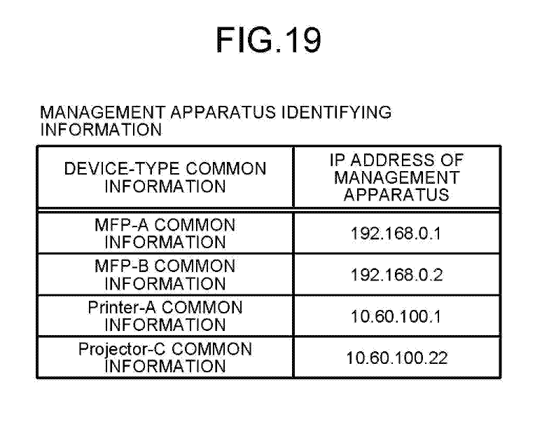

Described next is the management apparatus identifying information. FIG. 19 is a diagram illustrating an example of the management apparatus identifying information stored in the storage unit. As illustrated in FIG. 19, the management apparatus identifying information associates device-type common information that is product setting information common to each type of the devices with Internet protocol addresses (IP addresses) that uniquely identify the management apparatuses. The IP addresses correspond to management apparatus identification information.

Specifically, for example, as illustrated in FIG. 19, the management apparatus identifying information associates device-type common information “MFP-A common information” with an IP address of a management apparatus “192.168.0.1”. With reference to the management apparatus identifying information, the writing apparatus can identify a management apparatus that manages device-type common information. The product setting information generation unit 320 generates product setting information, and includes a identifying unit 321 and the acquisition unit 322.

The identifying unit 321 identifies the type of a device from device identification information, and identifies device individual information items from the type of the device in the same manner as in the first embodiment.

The identifying unit 321 further identifies device-type common information corresponding to the identified type of the device with reference to the common-information identifying information (FIG. 8). The identifying unit 321 identifies a management apparatus indicated by an IP address corresponding to the identified device-type common information with reference to the management apparatus identifying information. The identifying unit 321 corresponds to a common information identifying unit and a management apparatus identifying unit.

The acquisition unit 322 acquires device individual information corresponding to the identified device individual information items in the same manner as in the first embodiment.

The acquisition unit 322 acquires the desired device-type common information from the management apparatus identified by the identifying unit 321 through the communication unit 310.

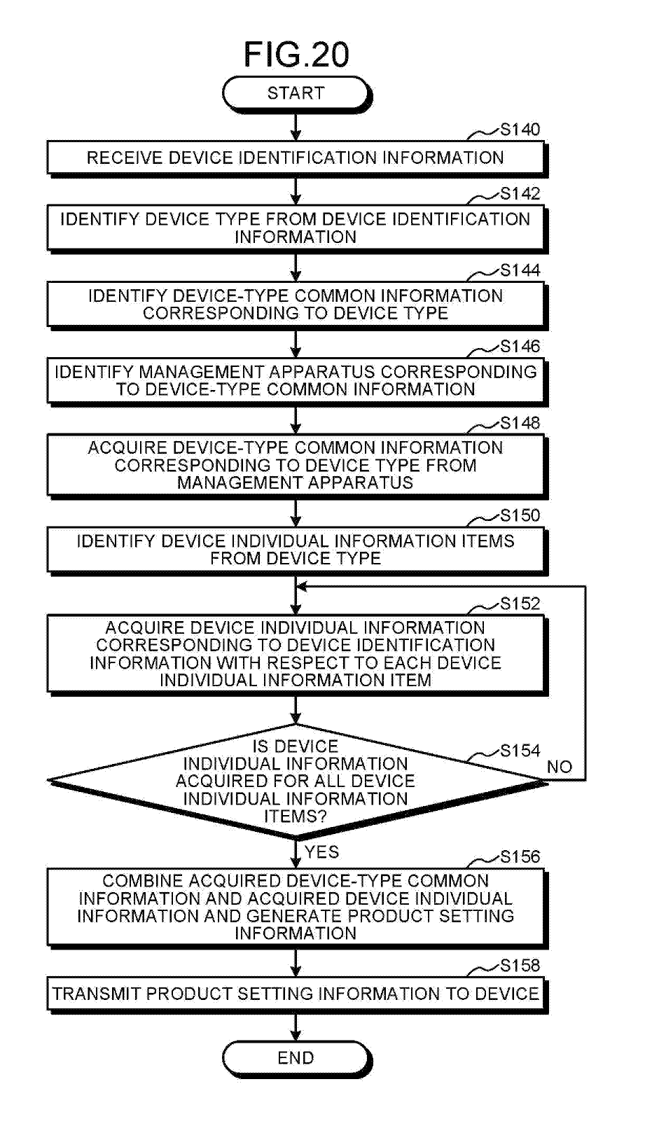

Described next is generation processing of the product setting information in the writing apparatus 300 according to the third embodiment. FIG. 20 is a flowchart illustrating the procedure for generating the product setting information in the writing apparatus according to the third embodiment.

The communication unit 310 transmits a request for device identification information to the devices, and receives device identification information from each device (Step S140). The identifying unit 321 identifies the type of a device corresponding to the received device identification information with reference to the device-type identifying information (Step S142).

The identifying unit 321 identifies device-type common information corresponding to the identified type of the device with reference to the common-information identifying information (Step S144). The identifying unit 321 identifies a management apparatus corresponding to the identified device-type common information with reference to the management apparatus identifying information (Step S146).

The acquisition unit 322 acquires the device-type common information corresponding to the type of the device from the identified management apparatus through the communication unit 310 (Step S148).

The steps (from Step S150 to Step S158) from specification of device individual information items to the end of the processing are the same as the steps (see Step S106 to Step S114) in the first embodiment and thus the explanation thereof is omitted.

As described above, in the writing system according to the third embodiment, the writing apparatus identifies the type of a device from device identification information received from the device, acquires device-type common information corresponding to the identified type from a management apparatus, and acquires device individual information corresponding to the device from device individual information items corresponding to the type of the device. The writing apparatus combines the acquired device-type common information with the acquired device individual information to generate product setting information, and transmits the product setting information to the device. The device writes the received product setting information. With this configuration, product setting information can be written to different types of devices under the same writing environment for the product setting information even when the devices include a device of a certain type that needs to write product setting information including individual information specific to the device.

In the writing system according to the third embodiment, the writing apparatus acquires device-type common information corresponding to a desired type from a management apparatus that manages the device-type common information. With this configuration, different management apparatuses can manage device-type common information for different device types, which is advantageous when device-type common information for different device types is managed by different departments, for example.

### Fourth Embodiment

The writing apparatus according to the third embodiment uses management apparatuses that are connected via the network to manage the device-type common information. In addition to this configuration, the writing apparatus according to a fourth embodiment identifies communication protocols between the writing apparatus and the management apparatuses, and acquires device-type common information from the management apparatuses using the identified communication protocols.

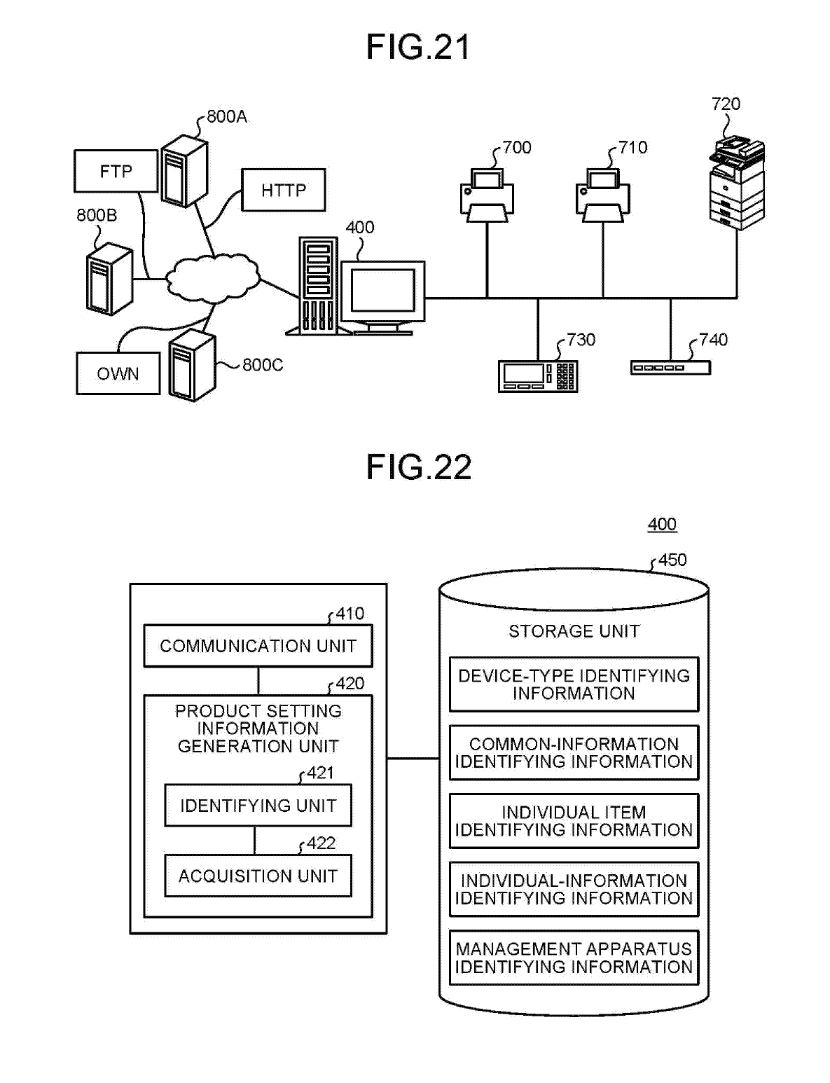

FIG. 21 is a diagram illustrating the entire configuration of a writing system according to the fourth embodiment. As illustrated in FIG. 21, in the writing system according to the fourth embodiment, a writing apparatus 400 is connected to a plurality of devices that are the printer 700, the printer 710, the MFP 720, the projector 730, and the network repeater 740 via a network. In the writing system according to the fourth embodiment, the management apparatuses 800A, 800B, and 800C are connected to the writing apparatus 400 via the network using different communication protocols. As illustrated in FIG. 21, examples of the communication protocols include file transfer protocol (FTP), hypertext transfer protocol (HTTP), and own protocols.

As described in the first embodiment, the devices in FIG. 21 are presented for illustrative purposes only. Although three management apparatuses are connected in the example of FIG. 21, the number of management apparatuses connected to the writing apparatus is not limited to three.

The hardware configuration of the writing apparatus and the printer that is an example of the devices is the same as in the first embodiment and thus the explanation thereof is omitted.

Described next is a functional configuration of the writing apparatus 400 according to the fourth embodiment with reference to FIG. 22. FIG. 22 is a diagram illustrating the functional configuration of the writing apparatus according to the fourth embodiment. As illustrated in FIG. 22, the writing apparatus 400 includes a communication unit 410 and a product setting information generation unit 420, and these units can access a storage unit 450 implemented by, for example, the HDD 55.

The communication unit 410 transmits and receives various types of information to and from the devices (such as the printer 700) and the management apparatuses 800A, 800B, and 800C that are connected to the network. The communication unit 410 transmits, to the devices connected via the network, a request for device identification information that identifies each device, and receives device identification information from the devices. In the fourth embodiment, the communication unit 410 transmits a request for device identification information to the printer 700 and receives, from the printer 700, the device identification information of the printer 700.

Upon receiving an instruction from an acquisition unit 422, the communication unit 410 transmits a request for device-type common information to a desired management apparatus, and receives the device-type common information from the management apparatus. The communication unit 410 transmits and receives information to and from the desired management apparatus using a communication protocol suitable for the management apparatus. The communication unit 410 transmits product setting information generated by the product setting information generation unit 420 to the device from which the device identification information has been transmitted, that is, to the printer 700 in the fourth embodiment.

The storage unit 450 stores therein device-type identifying information, common-information identifying information, individual item identifying information, individual-information identifying information, management apparatus identifying information, and actual values of these types of information. The device-type identifying information, the common-information identifying information, the individual item identifying information, and the individual-information identifying information are the same as in the first embodiment.

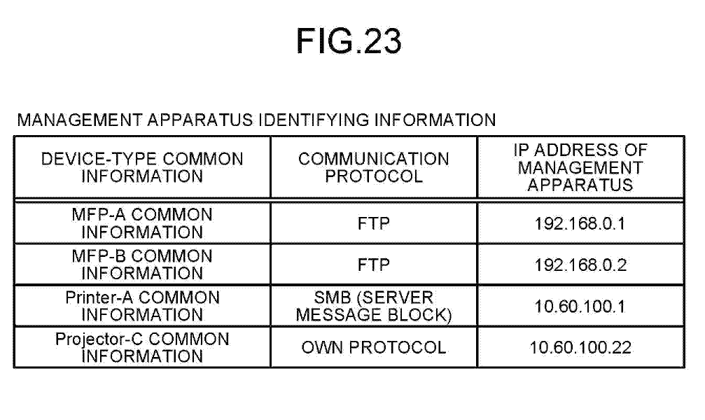

Described next is the management apparatus identifying information. FIG. 23 is a diagram illustrating an example of the management apparatus identifying information stored in the storage unit. As illustrated in FIG. 23, the management apparatus identifying information associates device-type common information that is product setting information common to each type of the devices with communication protocols that are used in communicating with the management apparatuses and IP addresses that uniquely identify the management apparatuses. The communication protocols correspond to a first communication mode.

Specifically, for example, as illustrated in FIG. 23, the management apparatus identifying information associates device-type common information “MFP-A common information” with a communication protocol “FTP” and an IP address of a management apparatus “192.168.0.1”. With reference to the management apparatus identifying information, the writing apparatus can identify a management apparatus that manages device-type common information, and identify a communication protocol to be used in communicating with the management apparatus. The product setting information generation unit 420 generates product setting information, and includes a identifying unit 421 and the acquisition unit 422.

The identifying unit 421 identifies the type of a device from device identification information, and identifies device individual information items from the type of the device in the same manner as in the first embodiment.

The identifying unit 421 identifies device-type common information corresponding to the identified type of the device with reference to the common-information identifying information (FIG. 8). The identifying unit 421 identifies a management apparatus indicated by an IP address corresponding to the identified device-type common information and identifies a communication protocol with reference to the management apparatus identifying information. The identifying unit 421 corresponds to the common information identifying unit and the management apparatus identifying unit.

The acquisition unit 422 acquires device individual information corresponding to the identified device individual information items in the same manner as in the first embodiment.

The acquisition unit 422 acquires desired device-type common information from the management apparatus identified by the identifying unit 421 using the identified communication protocol.

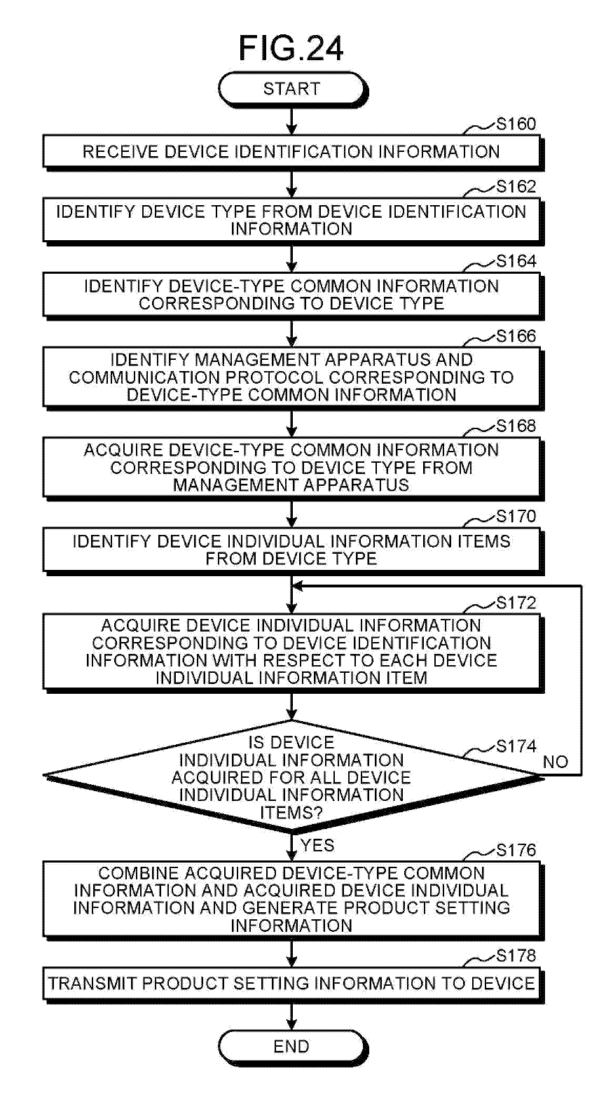

Described next is generation processing of the product setting information in the writing apparatus 400 according to the fourth embodiment. FIG. 24 is a flowchart illustrating the procedure for generating the product setting information in the writing apparatus according to the fourth embodiment.

The communication unit 410 transmits a request for device identification information to the devices, and receives device identification information from each device (Step S160). The identifying unit 421 identifies the type of a device corresponding to the received device identification information with reference to the device-type identifying information (Step S162).

The identifying unit 421 identifies device-type common information corresponding to the identified type of the device with reference to the common-information identifying information (Step S164). The identifying unit 421 identifies a management apparatus corresponding to the identified device-type common information and identifies a communication protocol for communicating with the management apparatus with reference to the management apparatus identifying information (Step S166).

The acquisition unit 422 acquires the device-type common information corresponding to the type of the device from the identified management apparatus using the identified communication protocol through the communication unit 410 (Step S168).

The steps (from Step S170 to Step S178) from specification of device individual information items to the end of the processing are the same as the steps (see Step S106 to Step S114) in the first embodiment and thus the explanation thereof is omitted.

As described above, in the writing system according to the fourth embodiment, the writing apparatus identifies the type of a device from device identification information received from the device, acquires device-type common information corresponding to the identified type from a management apparatus, and acquires device individual information corresponding to the device from device individual information items corresponding to the type of the device. The writing apparatus combines the acquired device-type common information with the acquired device individual information to generate product setting information, and transmits the product setting information to the device. The device writes the received product setting information. With this configuration, product setting information can be written to different types of devices under the same writing environment for the product setting information even when the devices include a device of a certain type that needs to write product setting information including individual information specific to the device.

In the writing system according to the fourth embodiment, the writing apparatus acquires device-type common information corresponding to a desired type from a management apparatus that manages the device-type common information. With this configuration, different management apparatuses can manage device-type common information for different device types, which is advantageous when device-type common information for different device types is managed by different departments, for example.

The writing system according to the fourth embodiment is applicable to a case in which different communication protocols are used in communicating with management apparatuses that manage the device-type common information (for example, constraints of the management apparatuses, preference of administrators of the management apparatuses, or communication almost always performed based on secure sockets layer (SSL) due to importance of information).

### Fifth Embodiment

The writing apparatus according to the first embodiment transmits a request for device identification information to the devices, receives device identification information from the devices, and transmits generated product setting information to the devices. In addition to this configuration, the writing apparatus according to a fifth embodiment identifies communication interfaces between the writing apparatus and the devices, and uses the identified communication interfaces to transmit and receive various types of information to and from the devices.

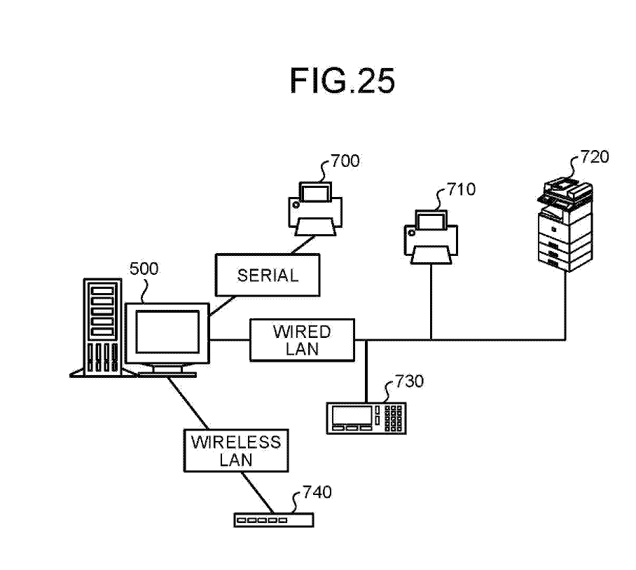

FIG. 25 is a diagram illustrating the entire configuration of a writing system according to the fifth embodiment. As illustrated in FIG. 25, in the writing system according to the fifth embodiment, a writing apparatus 500 is connected to a plurality of devices that are the printer 700, the printer 710, the MFP 720, the projector 730, and the network repeater 740 via a network through communication interfaces corresponding to the respective types of the devices. As described in the first embodiment, the devices in FIG. 25 are presented for illustrative purposes only.

The interfaces of some devices may vary depending on the type of the devices, and some devices may have difficulty in communicating via a local area network (LAN) due to, for example, implementation constraints. In FIG. 25, for example, the devices include a device that communicates with the writing apparatus 500 in serial communication, a device that communicates with the writing apparatus 500 via a wired LAN, and a device that communicates with the writing apparatus 500 via a wireless LAN. As described in the first embodiment, the devices in FIG. 25 are presented for illustrative purposes only.

The hardware configuration of the writing apparatus and the printer that is an example of the devices is the same as in the first embodiment and thus the explanation thereof is omitted.

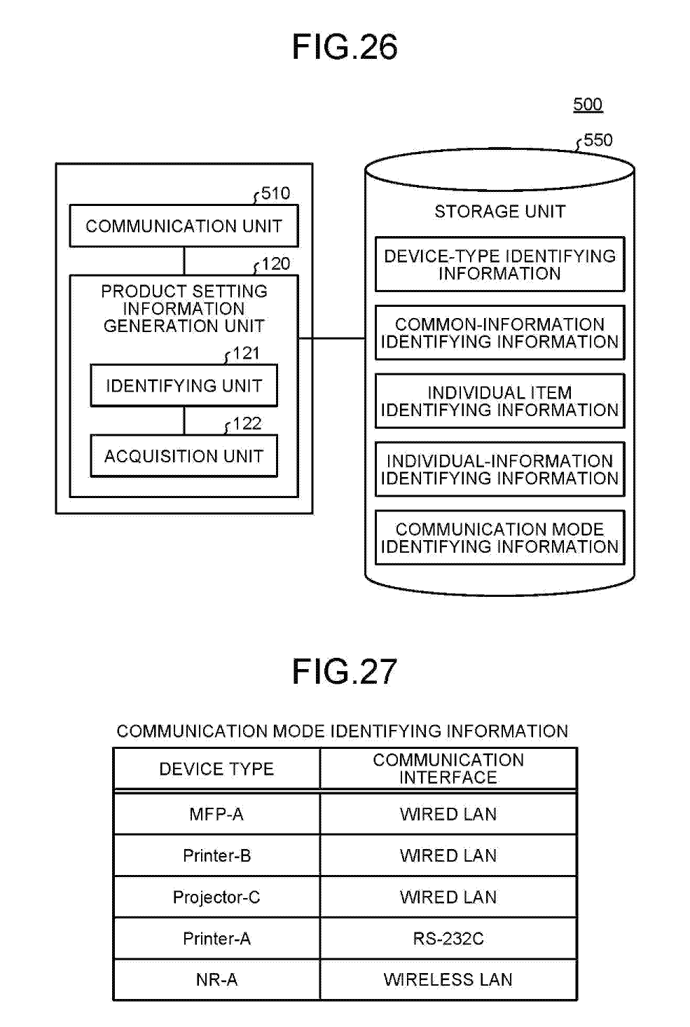

Described next is a functional configuration of the writing apparatus 500 according to the fifth embodiment with reference to FIG. 26. FIG. 26 is a diagram illustrating the functional configuration of the writing apparatus according to the fifth embodiment. As illustrated in FIG. 26, the writing apparatus 500 includes a communication unit 510 and a product setting information generation unit 120, and these units can access a storage unit 550 implemented by, for example, the HDD 55.

The communication unit 510 transmits and receives various types of information to and from the devices (such as the printer 700) connected to the network. The communication unit 510 transmits, to the devices connected via the network, a request for device identification information that identifies each device, and receives device identification information from the devices. In the fifth embodiment, the communication unit 510 transmits a request for device identification information to the printer 700 and receives, from the printer 700, the device identification information of the printer 700. The communication unit 510 transmits and receives information through communication interfaces suitable for the respective devices. The communication unit 510 transmits product setting information generated by the product setting information generation unit 120 to the device from which the device identification information has been transmitted, that is, to the printer 700 in the fifth embodiment.

The storage unit 550 stores therein device-type identifying information, common-information identifying information, individual item identifying information, individual-information identifying information, communication mode identifying information, and actual values of these types of information. The device-type identifying information, the common-information identifying information, the individual item identifying information, and the individual-information identifying information are the same as in the first embodiment.

Described next is the communication mode identifying information. FIG. 27 is a diagram illustrating an example of the communication mode identifying information stored in the storage unit. As illustrated in FIG. 27, the communication mode identifying information associates the types of the devices with communication interfaces of the devices. The communication interfaces correspond to a second communication mode.

Specifically, for example, as illustrated in FIG. 27, the communication mode identifying information associates the device type “MFP-A” with a communication interface “wired LAN”. With reference to the communication mode identifying information, the writing apparatus can identify a communication interface to be used in communicating with a device of a type to which the writing apparatus transmits the product setting information.

In other words, the communication unit 510 receives, from a device from which device identification information has been transmitted, the device identification information of the device through a communication interface corresponding to the type of the device with reference to the communication mode identifying information. The communication unit 510 transmits the generated setting information to the device from which the device identification information has been transmitted through the communication interface corresponding to the type of the device with reference to the communication mode identifying information.

The product setting information generation unit 120 has the same configuration and functions as in the first embodiment and thus the explanation thereof is omitted.

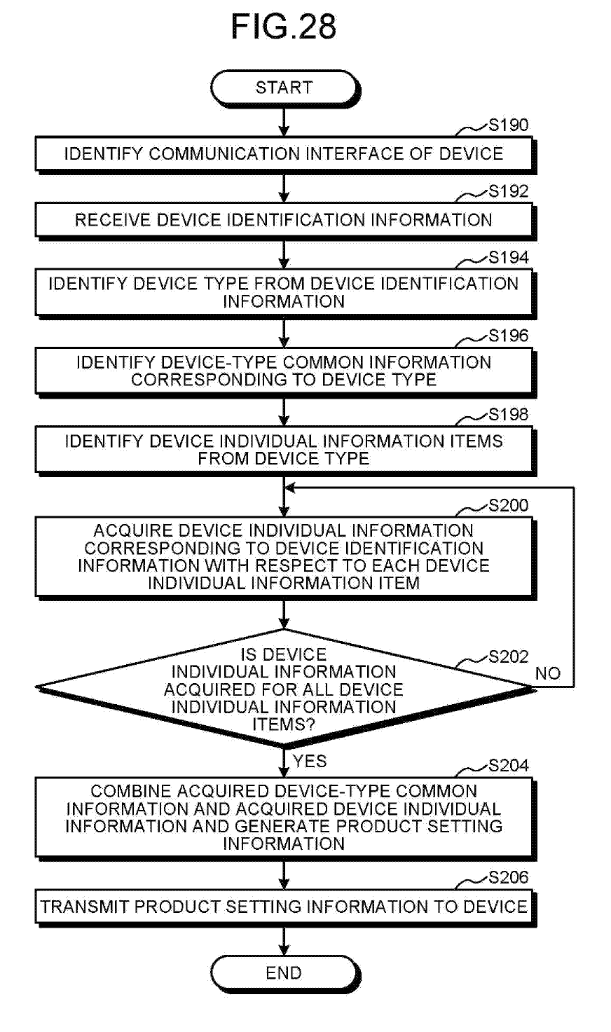

Described next is generation processing of the product setting information in the writing apparatus 500 according to the fifth embodiment. FIG. 28 is a flowchart illustrating the procedure for generating the product setting information in the writing apparatus according to the fifth embodiment.

The communication unit 510 identifies a communication interface of a desired device with reference to the communication mode identifying information (Step S190), transmits a request for device identification information to the device, and receives device identification information from the device (Step S192).

The steps (from Step S194 to Step S204) from specification of the type of the device by the identifying unit 121 to generation of the product setting information by the product setting information generation unit 120 are the same as the steps (see Steps S102 to Step S112) in the first embodiment and thus the explanation thereof is omitted.

The communication unit 510 transmits the generated product setting information to the device from which the device identification information has been transmitted through the identified communication interface (Step S206). The product setting information is written to the device.

As described above, in the writing system according to the fifth embodiment, the writing apparatus identifies the type of the device from device identification information received from the device, acquires device-type common information corresponding to the identified type, and acquires device individual information corresponding to the device from device individual information items corresponding to the type of the device. The writing apparatus combines the acquired device-type common information and the acquired device individual information to generate product setting information, and transmits the product setting information to the device. The device writes the received product setting information. With this configuration, product setting information can be written to different types of devices under the same writing environment for the product setting information even when the devices include a device of a certain type that needs to write product setting information including individual information specific to the device.

In the writing system according to the fifth embodiment, product setting information can be written to devices with different communication interfaces using a single writing apparatus 500.

The computer program executed in the writing apparatuses according to the first to the fifth embodiments is recorded in a computer-readable recording medium such as a compact disc read only memory (CD-ROM), a flexible disk (FD), a compact disc recordable (CD-R), and a digital versatile disc (DVD), as an installable or executable file, and is provided as a computer program product.

The computer program executed in the writing apparatuses according to the first to the fifth embodiments may be stored in a computer connected to a network such as the Internet and provided by being downloaded via the network. Furthermore, the computer program executed in the writing apparatuses according to the first to the fifth embodiments may be provided or distributed via a network such as the Internet.

The computer program executed in the writing apparatuses according to the first to the fifth embodiments may be embedded in a ROM in advance and provided, for example.

The computer program executed in the writing apparatuses according to the first to the fifth embodiments has a module configuration including the units (communication unit, product setting information generation unit) described above. As actual hardware, the CPU 51 (processor) reads the computer program from the recording medium and executes the computer program, so that these units are loaded and generated on a main memory. A part or all of the functions of the units above may be implemented by a dedicated hardware circuit, for example.

According to an embodiment, product setting information can be written to different types of devices under the same writing environment for the product setting information even when the devices include a device of a certain type that needs to write product setting information including individual information specific to the device.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An information processing apparatus connected to a plurality of devices via a network, the information processing apparatus comprising:
a storage unit configured to store device identification information that identifies the devices, types of the devices, device-type common information to be written commonly to devices of each type, and device individual information to be written individually to the devices in association with each other; and
circuitry configured to:
receive device identification information of each device from the device;
identify a type of the device, the type corresponding to the received device identification information, with reference to the storage unit;
acquire device-type common information corresponding to the identified type of the device with reference to the storage unit;
acquire device individual information corresponding to the identified type of the device and to the received device identification information with reference to the storage unit;
generate setting information to be written to the device from which the device identification information has been transmitted, from the acquired device-type common information and the acquired device individual information; and
transmit the generated setting information to the device from which the device identification information has been transmitted.

2. The information processing apparatus according to claim 1, wherein
the storage unit is configured to store:
device-type identifying information that associates the device identification information with the respective types of the devices;
common-information identifying information that associates the respective types of the devices with the device-type common information;
individual item identifying information that associates the respective types of the devices with device individual information items indicating items of the device individual information; and
individual-information identifying information that associates the device individual information items, the device identification information and the device individual information,
the circuitry is configured to:
identify the type of the device, the type corresponding to the received device identification information, with reference to the device-type identifying information;
acquire the device-type common information corresponding to the identified type of the device with reference to the common-information identifying information,
further identify at least one device individual information item corresponding to the identified type of the device with reference to the individual item identifying information; and
acquire the device individual information corresponding to a combination of the identified at least one device individual information item and the received device identification information with reference to the individual-information identifying information.

3. The information processing apparatus according to claim 2, wherein
the storage unit is further configured to store common item identifying information that associates the respective types of the devices with device-type common information items indicating items of the device-type common information,
the circuitry is further configured to
identify at least one device-type common information item corresponding to the identified type of the device with reference to the common item identifying information; and
acquire the device-type common information corresponding to the identified at least one device-type common information item.

4. The information processing apparatus according to claim 2, wherein
the information processing apparatus is further connected to management apparatuses via the network, and
the storage unit is further configured to store management apparatus identifying information that associates device-type common information with management apparatus identification information that identifies a management apparatus configured to manage the device-type common information,
the circuitry is further configured to:
identify the device-type common information corresponding to the identified type of the device with reference to the common information identifying information;
identify the management apparatus indicated by the management apparatus identification information corresponding to the identified device-type common information with reference to the management apparatus identifying information, and
acquire the identified device-type common information from the identified management apparatus.

5. The information processing apparatus according to claim 4, wherein
the circuitry is configured to:
further associate a first communication mode for use in communicating with the management apparatus with the device-type common information and the management apparatus identification information,
further identify the first communication mode corresponding to the identified management apparatus identification information with reference to the management apparatus identifying information, and
acquire the device-type common information from the management apparatus by the identified first communication mode.

6. The information processing apparatus according to claim 2, wherein
the storage unit is further configured to store communication mode identifying information that associates the type of the device with a second communication mode for use in communicating with the device from which the device identification information has been transmitted,
the circuitry is configured to
receive the device identification information of the device from the device by the second communication mode corresponding to the type of the device from which the device identification information has been transmitted with reference to the communication mode identifying information; and
transmit the generated setting information to the device by the second communication mode corresponding to the type of the device from which the device identification information has been transmitted with reference to the communication mode identifying information.

7. An information processing system comprising:
an information processing apparatus; and
a plurality of devices connected to the information processing apparatus via a network,
the information processing apparatus including:
a storage unit configured to store device identification information that identifies the devices, types of the devices, device-type common information to be written commonly to devices of each type, and device individual information to be written individually to the devices in association with each other; and
circuitry configured to:
receive device identification information of each device from the devices,
identify a type of the device, the type corresponding to the received device identification information, with reference to the storage unit,
acquire the device-type common information corresponding to the identified type of the device with reference to the storage unit,
acquire device individual information corresponding to the identified type of the device and to the received device identification information with reference to the storage unit,
generate setting information to be written to the device from which the device identification information has been transmitted, from the acquired device-type common information and the acquired device individual information; and
transmit the generated setting information to the device from which the device identification information has been transmitted, and
each of the devices including:
a second storage unit configured to store device identification information,
circuitry configured to:
transmit the device identification information to the information processing apparatus and receives setting information; and
write the received setting information into the second storage unit.

8. A non-transitory recording medium including a computer program to be executed by a computer connected to a plurality of devices via a network and including a storage unit configured to store device identification information that identifies the devices, types of the devices, device-type common information to be written commonly to devices of each type, and device individual information to be written individually to the devices, in association with each other, wherein
the computer program causes the computer to function as circuitry configured to:
receive device identification information of each device from the device;
identify a type of the device, the type corresponding to the received device identification information, with reference to the storage unit;
acquire the device-type common information corresponding to the identified type of the device with reference to the storage unit;
acquire the device individual information corresponding to the identified type of the device and to the received device identification information with reference to the storage unit;
generate setting information to be written to the device from which the device identification information has been transmitted, from the acquired device-type common information and the acquired device individual information; and
transmit the generated setting information to the device from which the device identification information has been transmitted.
